(19) United States
(12) Patent Application Publication
(10) Pub. No.: US 2024/0212633 A1
(43) Pub. Date: Jun. 27, 2024

(54) BRIGHTNESS ADJUSTING METHOD AND SYSTEM FOR DISPLAY APPARATUS

(71) Applicants: Beijing BOE Optoelectronics Technology Co., Ltd., Beijing (CN); BOE TECHNOLOGY GROUP CO., LTD., Beijing (CN)

(72) Inventors: Wenchao HAN, Beijing (CN); Wei SUN, Beijing (CN); Xinle WANG, Beijing (CN); Yifan SONG, Beijing (CN); Jing LIU, Beijing (CN); Xue DONG, Beijing (CN); Wanzhi CHEN, Beijing (CN)

(21) Appl. No.: 17/914,336

(22) PCT Filed: Oct. 25, 2021
(86) PCT No.: PCT/CN2021/125976

§ 371 Date: Sep. 24, 2022

(30) Foreign Application Priority Data
Apr. 28, 2021 (CN) 202110468374.6

(51) Int. Cl. G09G 3/34

(52) U.S. Cl. CPC G09G 3/3406; G09G 2320/041; G09G 2320/0626; G09G 2320/0693; G09G 2360/14

(57) ABSTRACT

The present disclosure provides a brightness adjusting method and system for a display apparatus, and belongs to the algorithm field. In the brightness adjusting method for a display apparatus provided by the present disclosure, the display apparatus includes a photosensitive sampling circuit, and the photosensitive sampling circuit includes at least one photosensitive device. The method includes: acquiring a current first sampling signal of each of the at least one photosensitive device; determining a second sampling signal of the photosensitive device according to an initial sampling signal acquired in advance and the first sampling signal; and calibrating the second sampling signal according to a preset calibration algorithm to obtain an actual sampling signal.

### TECHNICAL FIELD

The present disclosure relates to the algorithm field, and in particular, to a brightness adjusting method and system for a display apparatus.

### BACKGROUND

In the related art, a display apparatus includes a photosensitive module, a display panel, and a dimming unit. The photosensitive module is configured to detect the brightness information of the environment and feed the brightness information back to the dimming unit, and the dimming unit is configured to automatically adjust the display brightness of the display panel according to the brightness information. However, a sampling signal of the photosensitive module is easily affected by various factors, resulting in an inaccurate sampling signal and an inaccurate display brightness of the display panel adjusted by the dimming unit according to the sampling signal.

### SUMMARY

The present disclosure is directed to at least solving one of the technical problems in the prior art, and provides a brightness adjusting method for a display apparatus, where the display apparatus includes a photosensitive sampling circuit, and the method can calibrate a sampling signal of the photosensitive sampling circuit to ensure its accuracy.

In a first aspect, an embodiment of the present disclosure provides a brightness adjusting method for a display apparatus including a photosensitive sampling circuit, wherein the photosensitive sampling circuit includes at least one photosensitive device; wherein the method includes:
acquiring a current first sampling signal of each of the at least one photosensitive device; determining a second sampling signal of the photosensitive device according to an initial sampling signal acquired in advance and the first sampling signal; and
calibrating the second sampling signal according to a preset calibration algorithm to obtain an actual sampling signal.

According to the brightness adjusting method for the display apparatus, the second sampling signal is generated according to the initial sampling signal and the first sampling signal of the photosensitive device of the photosensitive sampling circuit, so that the deviation of the initial sampling signal is eliminated; and then the second sampling signal is calibrated according to the preset calibration algorithm to obtain the final actual sampling signal, therefore the accuracy of the sampling signal acquired by the photosensitive sampling circuit can be ensured.

In some examples, the photosensitive sampling circuit further includes a reference device;
the method further includes: acquiring the initial sampling signal;
wherein the initial sampling signal is a difference between signals acquired by the at least one photosensitive device and the reference device in a dark state.

In some examples, the photosensitive sampling circuit further includes a reference device; the acquiring a current first sampling signal of each of the at least one photosensitive device includes:
determining a first real-time sampling signal of the photosensitive device and a second real-time sampling signal of the reference device;
generating the first sampling signal of the photosensitive device according to a difference between the first real-time sampling signal and the second real-time sampling signal.

In some examples, the determining a second sampling signal of the photosensitive device according to an initial sampling signal acquired in advance and the first sampling signal includes:
generating the second sampling signal of the photosensitive device according to a difference between the initial sampling signal and the first sampling signal.

In some examples, before the calibrating the second sampling signal according to a preset calibration algorithm to obtain an actual sampling signal, the method further includes:
compensating the second sampling signal according to an ambient temperature.

In some examples, the photosensitive sampling circuit further includes a reference device; the compensating the second sampling signal according to an ambient temperature includes:
acquiring a change value of an output signal of the reference device;
determining a temperature compensation value corresponding to the change value according to a preset relationship between the change value and the temperature compensation value; and
compensating the second sampling signal according to the temperature compensation value.

In some examples, the compensating the second sampling signal according to the temperature compensation value includes: summing the temperature compensation value and the second sampling signal to compensate the second sampling signal.

In some examples, the preset calibration algorithm includes a plurality of brightness segments, each of which is provided with a corresponding calibration function.

In some examples, an independent variable of the calibration function is the second sampling signal and a dependent variable of the calibration function is the actual sampling signal; the calibration function for each of the plurality of brightness segments is a linear function.

In some examples, the plurality of brightness segments include eight brightness segments; the calibration functions F(X) for the eight brightness segments are:
F(X)=0.0485·X+0.983, (0≤X<105.532);
F(X)=0.1267·X−7.2696, (105.532≤X<275.7185);
F(X)=0.1878·X−24.116, (275.7185≤X<417.0865);
F(X)=0.2918·X−67.493, (417.0865≤X<576.4973);
F(X)=0.4217·X−142.38, (576.4973≤X<752.4153);
F(X)=0.6018·X−277.89, (752.4153≤X<948.6758);
F(X)=0.9001·X−560.88, (948.6758≤X<1201.839);
F(X)=1.5091·X−1292.8, (1201.839≤X);
   wherein X is the second sampling signal.

In some examples, the at least one photosensitive device includes a plurality of photosensitive devices, and
the method further includes determining brightness information of a current environment according to the actual sampling signal of each of the plurality of photosensitive devices.

In some examples, the display apparatus further includes a dimming unit and a light source,
the method further includes:
transmitting the brightness information to the dimming unit, so that the dimming unit determines a light emitting brightness of the light source according to the brightness information.

In some examples, the method further includes:
receiving a current light emitting brightness fed back by the dimming unit;
judging whether the current light emitting brightness is abnormal or not according to the preset correspondence between the brightness information and the light emitting brightness;
in response to the current light emitting brightness being abnormal, generating a brightness calibration signal, so that the dimming unit calibrates the light emitting brightness of the light source according to the brightness calibration signal.

In some examples, the judging whether the current light emitting brightness is abnormal or not according to the preset correspondence between the brightness information and the light emitting brightness includes:
acquiring the light emitting brightness corresponding to the brightness information last transmitted to the dimming unit;
judging whether a difference between the light emitting brightness and the current light emitting brightness is greater than a preset threshold;
in response to the difference between the light emitting brightness and the current light emitting brightness being greater than a preset threshold, judging that the current light emitting brightness is abnormal.

In some examples, the display apparatus further includes a light source, and the method further includes:
receiving brightness information fed back by the photosensitive sampling circuit;
determining the light emitting brightness of the light source according to the brightness information.

In some examples, the method further includes:
feeding back the current light emitting brightness to the photosensitive sampling circuit, so that the photosensitive sampling circuit judges whether the current light emitting brightness is abnormal or not according to the preset correspondence between the brightness information and the light emitting brightness.

In a second aspect, an embodiment of the present disclosure further provides a brightness adjusting system for a display apparatus, the display apparatus including a photosensitive sampling circuit configured to implement the above method.

In some examples, the system further includes a dimming unit configured to receive the brightness information fed back by the photosensitive sampling circuit; and determine the light emitting brightness of the light source according to the brightness information.

In some examples, the photosensitive sampling circuit includes:
at least one photosensitive device;
a signal processing circuit connected to the at least one photosensitive device and configured to generate the brightness information according to an output signal of the at least one photosensitive device.

In some examples, the signal processing circuit includes: an analog-to-digital converter, a microcontroller unit and a random access memory connected between the analog-to-digital converter and the microcontroller unit; wherein,
the analog-to-digital converter is connected to the at least one photosensitive device and is configured to convert an output signal of the at least one photosensitive device into a digital signal; the random access memory is configured to temporarily store the digital signal therein, call the preset calibration algorithm and transmit the digital signal and the preset calibration algorithm to the microcontroller unit; the microcontroller unit is configured to calibrate the digital signal according to the preset calibration algorithm.

In some examples, the display apparatus includes: a display panel and a driving unit connected to the display panel;
the photosensitive sampling circuit includes: at least one photosensitive device and at least one reference device in the display panel;
the photosensitive sampling circuit further includes: a signal processing circuit connected to the at least one photosensitive device and the at least one reference device and integrated in the driving unit.

In some examples, the system further includes a dimming unit including:
an acquisition module configured to receive the brightness information fed back by the photosensitive sampling circuit;
a light source brightness module connected to the acquisition module and configured to determine the light emitting brightness of the light source according to the brightness information.

### BRIEF DESCRIPTION OF DRAWINGS

FIG. 1 is a flowchart of a first brightness adjusting method for a display apparatus according to an embodiment of the present disclosure.

FIG. 2a is a schematic diagram of a brightness adjusting system for a display apparatus according to an embodiment of the present disclosure.

FIG. 2b is a schematic diagram of a first structure of a photosensitive device of a photosensitive sampling circuit according to an embodiment of the present disclosure.

FIG. 2c is a schematic diagram of a second structure of a photosensitive device of a photosensitive sampling circuit according to an embodiment of the present disclosure.

FIG. 3 is a flowchart of a second brightness adjusting method for a display apparatus according to an embodiment of the present disclosure.

FIG. 4 is a flowchart of a third brightness adjusting method for a display apparatus according to an embodiment of the present disclosure.

FIG. 5 is a graph illustrating a sampling signal versus actual brightness before and after calibration in a brightness adjusting method for a display apparatus according to an embodiment of the present disclosure.

FIG. 6 is a flowchart of a fourth brightness adjusting method for a display apparatus according to an embodiment of the present disclosure.

FIG. 7 is a fifth flowchart of a brightness adjusting method for a display apparatus according to an embodiment of the present disclosure.

FIG. 8 is a sixth flowchart of a brightness adjusting method for a display apparatus according to an embodiment of the present disclosure.

FIG. 9 is a seventh flowchart of a brightness adjusting method for a display apparatus according to an embodiment of the present disclosure.

FIG. 10 is an eighth flowchart of a brightness adjusting method for a display apparatus according to an embodiment of the present disclosure.

FIG. 11 is a ninth flowchart of a brightness adjusting method for a display apparatus according to an embodiment of the present disclosure.

FIG. 12 is a tenth flowchart of a brightness adjusting method for a display apparatus according to an embodiment of the present disclosure.

FIG. 13 is a lookup table for a variation value and a temperature compensation value of a brightness adjusting method for a display apparatus according to an embodiment of the present disclosure.

FIG. 14 is a flowchart illustrating an algorithm for a brightness adjusting method for a display apparatus according to an embodiment of the present disclosure.

FIG. 15 is a schematic diagram of a structure of a dimming unit of a brightness adjusting system for a display apparatus according to an embodiment of the present disclosure.

### DETAIL DESCRIPTION OF EMBODIMENTS

To make objects, technical solutions and advantages of the present disclosure clear, the present disclosure will be described in further detail with reference to the accompanying drawings, and it is apparent that the described embodiments are only some embodiments of the present disclosure, not all embodiments. All other embodiments, which may be derived by a person skilled in the art from the embodiments disclosed herein without any creative effort, shall fall within the protection scope of the present disclosure.

Shapes and sizes of components in the drawings are not to scale, but are merely intended to facilitate an understanding of the contents of the embodiments of the present disclosure.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”, “an”, “the”, or the like used herein does not denote a limitation of quantity, but rather denotes the presence of at least one element. The term of “comprising”, “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may also be changed accordingly.

Transistors used in the embodiments of the present disclosure may be thin film transistors or field effect transistors or other devices with the same characteristics. Source and drain electrodes of each transistor are interchanged under certain conditions, so that the source and drain electrodes are equal to each other in the connection relationship. In the embodiments of the present disclosure, to distinguish the source electrode and the drain electrode of the transistor, one of the electrodes is referred to as a first electrode, the other electrode is referred to as a second electrode, and a gate electrode is referred to as a control electrode. In addition, the transistors may be divided into N-type and P-type transistors according to the characteristics of the transistors. In the following embodiments, the transistors are the P-type transistors, as an example. When the P-type transistors are used, the first electrode is the source electrode of the P-type transistor, the second electrode is the drain electrode of the P-type transistor. When a low level signal is input to the gate electrode, the source electrode and the drain electrode are conducted. When the N-type transistors are used, the first electrode is the drain electrode of the N-type transistor, and the second electrode is the source electrode of the N-type transistor. When a high level signal is input to the gate electrode, the source electrode and the drain electrode are conducted. It is contemplated that the implementation adopting the N-type transistors will be readily apparent to one skilled in the art without inventive effort, which is within the scope of the embodiment of the present disclosure.

The embodiments of the present disclosure are not limited to the embodiments shown in the drawings, but include modifications of configurations formed based on a manufacturing process. Thus, regions illustrated in the drawings have schematic properties, and shapes of the regions shown in the drawings illustrate specific shapes of regions of elements, but are not intended to be limiting.

As an example, an exemplary display apparatus includes a display panel, a dimming unit, and a photosensitive module, where the photosensitive module is usually externally disposed outside the display panel, and is used to detect brightness information of ambient light and return the detected brightness information to the dimming unit, and the dimming unit adjusts display brightness of the display panel according to the brightness information. However, it is required to separately add process steps for the external photosensitive module, and the requirement on the consistency of the process is strict, so that the process difficulty is high, and the cost is high. Moreover, the brightness information acquired by the photosensitive module may be directly fed back to the dimming unit, and the output signal of the photosensitive module will change due to illumination, and factors such as characteristics of the photosensitive module and ambient temperature, so that the generated brightness information is inaccurate, and further, the display brightness of the display panel adjusted according to the brightness information is inaccurate.

In order to solve the above problem, embodiments of the present disclosure provide a brightness adjusting method for a display apparatus, which can calibrate the brightness information acquired by a photosensitive device, as described below.

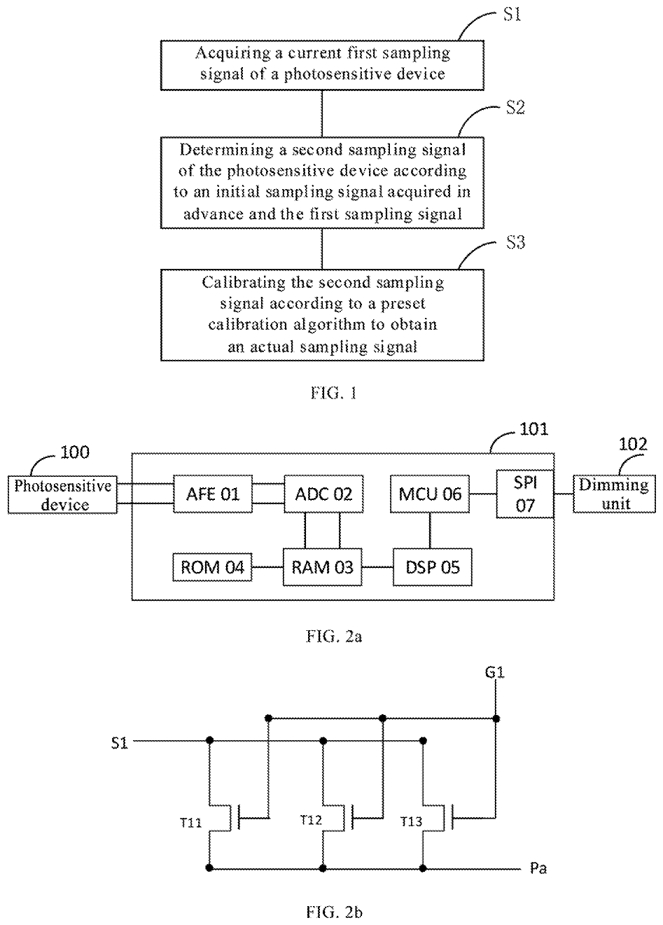

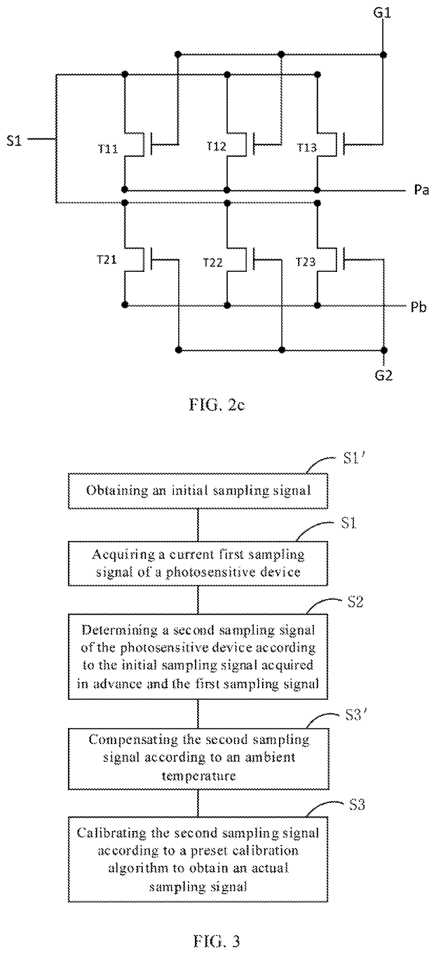

In a first aspect, referring to FIGS. 1, 2a, and 2b, an embodiment of the present disclosure provides a brightness adjusting method for a display apparatus, which is applied to a photosensitive sampling circuit of the display apparatus. The photosensitive sampling circuit includes a photosensitive device 100 and a signal processing circuit 101. A sampling signal of the photosensitive device 100 is input to the signal processing circuit 101, and the signal processing circuit 101 processes the sampling signal of the photosensitive device 100 to calibrate the sampling signal, so as to ensure accuracy of the sampling signal. The display apparatus may further include a dimming unit 102, a light source (not shown), and a display panel (not shown). The dimming unit 102 is connected to the signal processing circuit 101, and determines the light emitting brightness of the light source according to the brightness information corresponding to the sampling signal input by the signal processing circuit 101, so as to adjust the display brightness of the display panel.

It should be noted that the light source may be configured as a backlight or a front light source. Specifically, the light source (the backlight or the front light source) may be a side-light type or a direct type, which is not limited herein.

It should be noted that the photosensitive device 100 may be a phototransistor. The phototransistor may be integrated in the display panel, which can save the space and cost of the panel compared with an external photosensitive module. The following description will be given by taking the photosensitive device 100 being a phototransistor as an example.

Referring to FIG. 2b, as an example, the photosensitive device 100 is a phototransistor, and the photosensitive sampling circuit includes three phototransistors (T11, T12 and T13). A control electrode of the phototransistor T11, a control electrode of the phototransistor T12 and a control electrode of the phototransistor T13 are all connected to a first gate line G1; a first electrode of the phototransistor T11, a first electrode of the phototransistor T12 and a first electrode of the phototransistor T13 are all connected to a data line S1. The first gate line G1 loads a first voltage to the control electrodes of the three phototransistors, respectively; the data line S1 loads a second voltage to the first electrodes of the three phototransistors, respectively, to control a turn-on voltage of the phototransistors. A second electrode of the phototransistor T11, a second electrode of the phototransistor T12 and a second electrode of the phototransistor T13 are used as a reading port (for example, Pa in the drawings), sampling signals of the three phototransistors are read through the reading port, and are transmitted to the signal processing circuit 101 for processing.

Referring to FIG. 2a, the signal processing circuit 101 may include at least an analog-to-digital converter (ADC) 02, a microcontroller unit (MCU) 06, and a random access memory (RAM) 03 connected between the ACD 02 and the MCU 06. The ADC 02 is connected to at least one photosensitive device 100, and is configured to convert an output signal (analog voltage) of the at least one photosensitive device 100 into a sampling signal (digital signal); the RAM 03 is configured to temporarily store the received sampling signal therein, call a preset calibration algorithm from an internal or external memory, and transmit the sampling signal and the preset calibration algorithm to the MCU 06; the MCU 06 is configured to calibrate the sampling signal according to the preset calibration algorithm.

In some examples, the signal processing circuit 101 may also include a front end sub-circuit (AFE) 01, a read only memory (ROM) 04, a digital signal processor (DSP) 05, and a serial peripheral interface (SPI) 07. The AFE 01 is electrically connected to the photosensitive device 100, and is configured to convert an output current of the photosensitive device 100 into an output voltage and amplify the output voltage; the ADC 02 is electrically connected to the AFE 01, and is configured to convert an output signal (analog voltage) into a sampling signal (digital signal); the RAM 03 is electrically connected to the ADC 02, and the RAM 03 is configured to read and temporarily store the sampling signal input by the ADC 02 therein and read a required algorithm or data from the ROM 04; the ROM 04 is electrically connected to the RAM 03, and is configured to store data which need to be stored for a long time and are adopted by the signal processing circuit 101, such as algorithms and lookup tables or the like; the DSP 05 receives the sampling signal and the algorithm input by the RAM 03 and may preprocess the sampling signal; the MCU 06 receives the preprocessed sampling signal and the algorithm input by the DSP 05, may process the sampling signal according to a preset algorithm to obtain the calibrated sampling signal, then transmit the calibrated sampling signal to the SPI 07, which, in turn, inputs the calibrated sampling signal to the dimming unit 102 of the display panel, and the dimming unit 102 determines the light emitting brightness of the light source according to the brightness information corresponding to the sampling signal.

It should be noted that in the photosensitive sampling circuit, the output signal of the photosensitive device 100 is input to the signal processing circuit 101 and then converted by the ADC 02 into the digital signal, so that the sampling signals processed in the brightness adjusting method for the display apparatus according to the embodiment of the present disclosure are all digital signals. The sampling signals are, for example, a first sampling signal, an initial sampling signal, a second sampling signal, and the like.

The brightness adjusting method for the display apparatus of the embodiment of the present disclosure may include steps of:

S1, acquiring a current first sampling signal P1 of a photosensitive device 100.

Specifically, the signal processing circuit 101 acquires the first sampling signal P1 of the photosensitive device 100, that is, a real-time output signal detected by the photosensitive device 100 under a current ambient light.

S2, determining a second sampling signal P0 of the photosensitive device according to an initial sampling signal P0 acquired in advance and the first sampling signal P1.

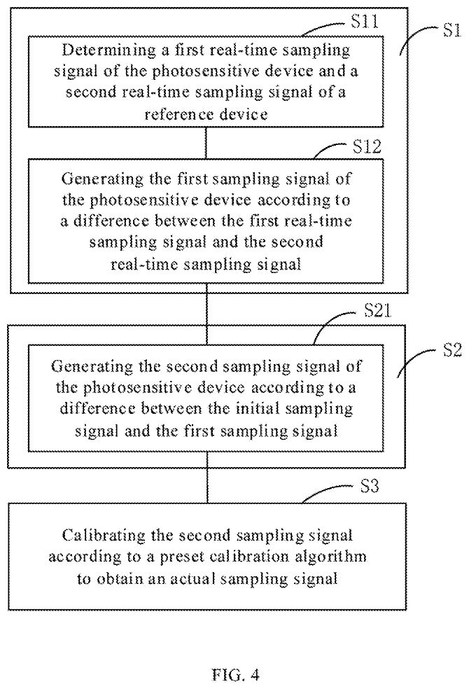

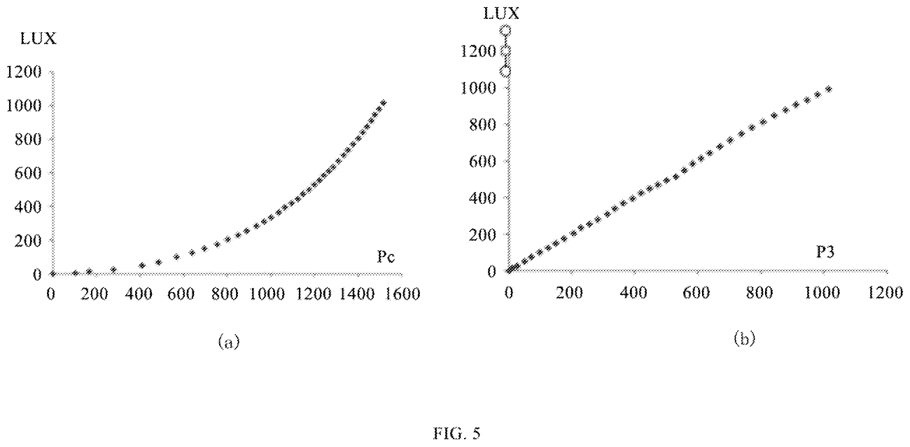

Specifically, referring to FIG. 4, S2 may specifically include:

S21, generating the second sampling signal P2 of the photosensitive device according to a difference between the initial sampling signal P0 and the first sampling signal P1.

Specifically, the photosensitive device 100 itself generates an output current in a dark state (where no light is substantially present), so that the initial sampling signal P0 of the photosensitive device 100 may be acquired in advance in the dark state as a reference value of the photosensitive device 100, and after the first sampling signal P1 of the photosensitive device 100 is acquired, the second sampling signal P2 is determined according to the difference between the first sampling signal P1 and the initial sampling signal P0 of the photosensitive device 100.

In some examples, the second sampling signal P2 may be obtained according to the difference between the first sampling signal P1 and the initial sampling signal P0, that is, P2=P1−P0. The second sampling signal P2 is a sampling signal of the photosensitive device 100 without the output current generated in the dark state, and this sampling signal may be considered to be generated only by light irradiation, so that the brightness information of the environment can be reflected more accurately.

S3, calibrating the second sampling signal P2 according to a preset calibration algorithm to obtain an actual sampling signal P3.

In some examples, the preset calibration algorithm may employ one of a plurality of calibration algorithms. For example, the second sampling signal P2 is actually represented as a brightness value detected by the photosensitive device 100, and the second sampling signal P2 may be divided into a plurality of brightness segments in advance. For example, the second sampling signal P2 is in a signal range of [0, 1201.839], and an upper limit of the specific signal range may be determined according to the kind of the photosensitive device 100 specifically employed and the required detection scenario. According to a desired adjusting fineness, the signal range [0, 1201.839] of the second sampling signal P2 is divided into a plurality of brightness segments. As an example, [0, 1201.839] is divided into eight brightness segments, which are: a first segment, 0≤X<105.532; a second segment, 105.532≤X<275.7185; a third segment, 275.7185≤X<417.0865; a fourth segment, 417.0865≤X<576.4973; a fifth segment, 576.4973≤X<752.4153; a sixth segment, 752.4153≤X<948.6758; a seventh segment, 948.6758≤X<1201.839; and an eighth segment, 1201.839≤X. Each brightness segment is configured with a corresponding calibration function, and the calibration function corresponding to the brightness segment is called according to a brightness segment to which the second sampling signal P2 belongs, and the second sampling signal P2 is calibrated according to the calibration function, so as to obtain the actual sampling signal P3.

In some examples, the calibration function for each brightness segment may be denoted as F(X)=a·X+b, where the independent variable X of the calibration function for each brightness segment is the second sampling signal P2 and the dependent variable F(X) is the actual sampling signal P3, i.e. the calibration function for each brightness segment may be denoted as P3=a·P2+b. The compensation coefficient a and the compensation value b may be determined in a pretest for the photosensitive device 100, that is, the photosensitive device 100 is subjected to a photosensitive test at the room temperature in advance, a difference between the second sampling signal P2 output by the photosensitive device 100 and the actual ambient brightness is determined, and the magnitudes of the compensation coefficient a and the compensation value b are determined according to the difference, so that the second sampling signal P2 may be matched with the actual ambient brightness. The compensation coefficients a and the compensation values b corresponding to the second sampling signal P2 in brightness segments of the second sampling signal P2 are respectively averaged, so that the compensation coefficient a and the compensation value b of the calibration function corresponding to each brightness segment are determined.

In some embodiments, taking the signal range of the second sampling signal P2 divided into the first to eighth brightness segments as an example, a specific calibration algorithm is illustrated. However, the present disclosure is not limited to the calibration algorithm. In the calibration algorithm preset in the brightness adjusting method for the display apparatus of the present embodiment, the calibration functions F(X) of brightness segments are:
F(X)=0.0485·X+0.983, (the first brightness segment, 0≤X<105.532);
F(X)=0.1267·X−7.2696, (the second brightness segment, 105.532≤X<275.7185);
F(X)=0.1878·X−24.116, (the third brightness segment, 275.7185≤X<417.0865);
F(X)=0.2918·X−67.493, (the fourth brightness segment, 417.0865≤X<576.4973);
F(X)=0.4217·X−142.38, (the fifth brightness segment, 576.4973≤X<752.4153);
F(X)=0.6018·X−277.89, (the sixth brightness segment, 752.4153≤X<948.6758);
F(X)=0.9001·X−560.88, (the seventh brightness segment, 948.6758≤X<1201.839); and
F(X)=1.5091·X−1292.8, (the eighth brightness segment, 1201.839≤X).

X is the second sampling signal P2, and F(X) is the actual sampling signal P3.

By taking the calibration algorithm as an example, if a magnitude of the second sampling signal P2 of the photosensitive device 100 is 523.572 and belongs to a fourth brightness segment, the calibration function for the fourth brightness segment is F(X)=0.2918·X−67.493, and finally the actual sampling signal P3 is 85.2853 by calculation.

The calibration algorithm may be stored in the ROM 04, or may be stored in an external memory outside the signal processing circuit 101. As an example, the calibration algorithm is stored in the ROM 04, the output signal of the photosensitive device 100 is converted by the AFE 01 and the ADC 02 into the first sampling signal P1, which is the digital signal, and is transmitted to the RAM 03; the RAM 03 calls the calibration algorithm stored in the ROM 04, and transmits the first sampling signal P1 and the calibration algorithm to the DSP 05; and the DSP 05 may preprocess the first sampling signal P1, wherein the preprocessing includes various arithmetic processing such as summation or difference calculation. Specifically, for example, the preprocessing may include determining the second sampling signal P2 of the photosensitive device 100 according to the difference between the initial sampling signal P0 acquired in advance and the first sampling signal P1. The DSP 05 transmits the preprocessed sampling signal (e.g., the second sampling signal P2) to the MCU 06; the MCU 06 determines a brightness segment to which the second sampling signal P2 belongs, determines a corresponding calibration function according to the brightness segment, and calibrates the second sampling signal P2 according to the calibration function to obtain the actual sampling signal P3.

It should be noted that the signal processing circuit 101 may be provided with only the MCU 06. In this embodiment, the MCU 06 is directly connected to the RAM 03, and all the operations are performed by the MCU 06.

In some examples, as may be seen from the above description, the calibration function F(X)=a·X+b for each brightness segment is a linear function, and thus, referring to FIG. 5, FIG. 5(a) is a graph of a sampling signal Pc of an un-calibrated photosensitive device 100 and the actual brightness LUX, FIG. 5(b) is a graph of the actual sampling signal P3 calibrated by the calibration algorithm of the embodiment of the present disclosure and the actual brightness LUX, and the calibrated calibration function F(X) is a linear function, thereby simplifying the computation amount.

It should be noted that the photosensitive sampling circuit may include a plurality of photosensitive devices 100, and may alternatively include one photosensitive device 100. If the photosensitive sampling circuit includes a plurality of photosensitive devices 100, the photosensitive sampling circuit receives a sampling signal of each photosensitive device of the plurality of photosensitive devices 100, calibrates each sampling signal to obtain each actual sampling signal, converts the actual sampling signals of the plurality of photosensitive devices 100 into brightness information, and transmits the brightness information to the dimming unit 102; if only one photosensitive device 100 is included, the actual sampling signal obtained from the sampling signal of the photosensitive device 100 is the brightness information, which may be specifically set as needed, and is not limited herein.

According to the brightness adjusting method for the display apparatus provided by an embodiment of the present disclosure, the second sampling signal P2 is generated according to the initial sampling signal P0 and the first sampling signal P1 of the photosensitive device 100 of the photosensitive sampling circuit, so that the deviation of the output signal generated by the characteristics of the photosensitive device 100 is eliminated; the second sampling signal P2 is calibrated according to the preset calibration algorithm to obtain the final actual sampling signal P3, wherein each calibration function in the calibration algorithm is a linear function, so that the accuracy of the sampling signal acquired by the photosensitive sampling circuit may be ensured, and the accuracy of the brightness information may be further ensured.

In some examples, the photosensitive sampling circuit may be provided with a photosensitive device, and may also be configured with a reference device. Specifically, as an example, both the photosensitive device and the reference device employ a phototransistor, where a light shielding layer is disposed on a photosensitive surface of the reference device, so that the reference device does not cause a change in an output signal due to a change in illumination, and only causes a change in the output signal due to its own characteristics and an ambient temperature. Referring to FIG. 2c, as an example, the photosensitive sampling circuit includes three phototransistors (T11, T12 and T13, respectively) as photosensitive devices and three phototransistors (T21, T22 and T23, respectively) as reference devices, each of the three phototransistors (T21, T22 and T23, respectively) as reference devices is provided with a light-shielding layer thereon. A control electrode of the phototransistor T11, a control electrode of the phototransistor T12, and a control electrode of the phototransistor T13, with the phototransistor T11, the phototransistor T12, and the phototransistor T13 being used as the photosensitive devices, are all connected to one first gate line G1; a control electrode of the phototransistor T21, a control electrode of the phototransistor T22, and a control electrode of the phototransistor T23, with the phototransistor T21, the phototransistor T22, and the phototransistor T23 being used as the reference devices, are all connected to one second gate line G2; and a first electrode of the phototransistor T1l, a first electrode of the phototransistor T12, a first electrode of the phototransistor T13, a first electrode of the phototransistor T21, a first electrode of the phototransistor T22, and a first electrode of the phototransistor T23 are all connected to one data line S1. The first gate line G1 respectively loads a first voltage to the control electrodes of the phototransistor T11, the phototransistor T12 and the phototransistor T13; the data line S1 respectively loads a second voltage to the first electrodes of the phototransistor T11, the phototransistor T12 and the phototransistor T13, to control turn-on voltages of the phototransistor T11, the phototransistor T12 and the phototransistor T13; a second electrode of the phototransistor T11, a second electrode of the phototransistor T12 and a second electrode of the phototransistor T13 serve as a first reading port Pa, and the sampling signals of the three phototransistors serving as the photosensitive devices are read through the first reading port Pa; the second gate line G2 respectively loads a third voltage to the control electrodes of the phototransistor T21, the phototransistor T22 and the phototransistor T23; the data line S1 respectively loads the second voltage to the first electrodes of the phototransistor T21, the phototransistor T22 and the phototransistor T23 to control turn-on voltages of the phototransistor T21, the phototransistor T22 and the phototransistor T23; a second electrode of the phototransistor T21, a second electrode of the phototransistor T22 and a second electrode of the phototransistor T23 serve as a second reading port Pb, and the sampling signals of the three phototransistors serving as reference devices are read through the second reading port Pb.

It should be noted that the number of the photosensitive devices and the reference devices included in the specific photosensitive sampling circuit is not limited, for example, the photosensitive sampling circuit includes a plurality of photosensitive devices and a plurality of reference devices, wherein the control electrodes of every 300 photosensitive devices are connected to the same first gate line G1, and the second electrodes are connected together as the first reading port Pa; the control electrodes of every 300 reference devices are connected to the same second gate line G2, and the second electrodes are connected together as the second reading port Pb; the first electrodes of the 300 photosensitive devices and the first electrodes of the 300 reference devices are connected to the same data line S1, that is, the 300 photosensitive devices and the 300 reference devices connected to the same data line S1 are used as one photosensitive unit.

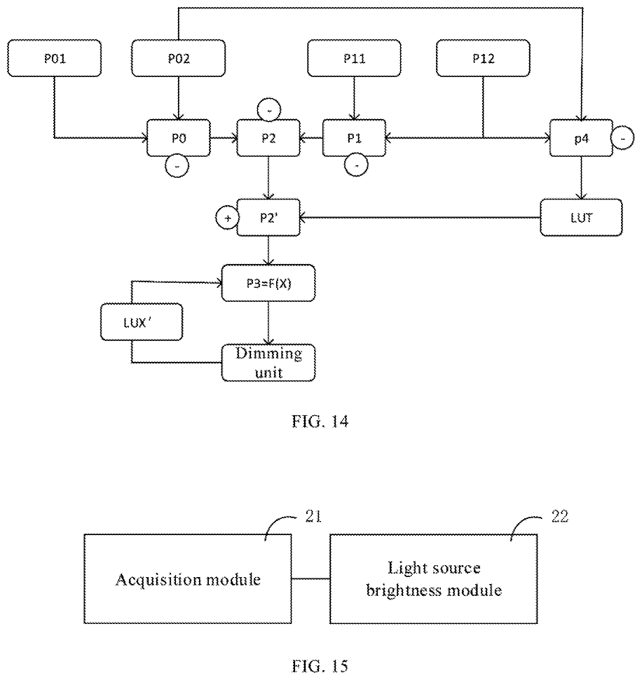

Referring to FIG. 4 and FIG. 14, in the embodiment of the photosensitive sampling circuit shown in FIG. 2c, for example, S1 in the method specifically includes:

S11, determining a first real-time sampling signal P11 of the photosensitive device and a second real-time sampling signal P12 of a reference device.

Specifically, the signal processing circuit 101 obtains the first real-time sampling signal P11 of the photosensitive device, that is, the signal processing circuit 101 obtains a real-time output signal detected by the photosensitive device 100 under the current ambient light through the first reading port Pa; the signal processing circuit 101 obtains the second real-time sampling signal P12 of the reference device, that is, the signal processing circuit 101 obtains a real-time output signal detected by the reference device under the current ambient light through the second reading port Pb.

S12, generating the first sampling signal P1 of the photosensitive device according to a difference P12 between the first real-time sampling signal P11 and the second real-time sampling signal.

Specifically, since the light shielding layer is disposed on the reference device, the second real-time sampling signal P12 of the reference device does not change due to the change in the ambient light. Therefore, the second real-time sampling signal P12 of the reference device may reflect the change in the output signal caused by characteristics of the phototransistor. The first real-time sampling signal P11 of the photosensitive device reflects the change in the output signal caused by characteristics of the phototransistor and the change in the ambient light. Therefore, the first sampling signal P1 obtained according to the first real-time sampling signal P11 and the second real-time sampling signal P12 may eliminate the deviation caused by the change in the signal generated by the characteristics of the photosensitive device, so that the sampling signal is more accurate.

In some examples, the first sampling signal P1 is the difference between the first real-time sampling signal P11 and the second real-time sampling signal P12, i.e., P1=P11-P12.

In some examples, referring to FIGS. 3 and 14, the method may further include:

S1′, obtaining the initial sampling signal P0. The initial sampling signal P0 is the difference between the signals acquired by the photosensitive device and the reference device in the dark state.

Specifically, the photosensitive device and the reference device itself generate an output current in a dark state (where no light is substantially present), so that a first dark-state sampling signal P01 of the photosensitive device may be acquired in advance in the dark state as a reference value of the photosensitive device, and a second dark-state sampling signal P02 of the reference device may be acquired in advance in the dark state as a reference value of the reference device. In this way, the initial sampling signal P0 may be derived according to a difference between the first dark-state sampling signal P01 and the second dark-state sampling signal P02, and the initial sampling signal P0 obtained in this way may eliminate the deviation in the output signal generated by the characteristics of the photosensitive device, so that the calibration of the sampling signal is more accurate.

It should be noted that a test environment for obtaining the first dark-state sampling signal P01 and the second dark-state sampling signal P02 is at a normal temperature (approximately equal to 25°).

In some examples, the output signal of the photosensitive device may not only change due to illumination but also change due to temperature change, the output signal of the reference device may not change due to illumination, so that the output signal of the reference device may be regarded as a response to the change in the output signal due to temperature change. Based on the above, with continued reference to FIG. 3, before S3, the method may further include:

S3′, compensating the second sampling signal P2 according to the ambient temperature.

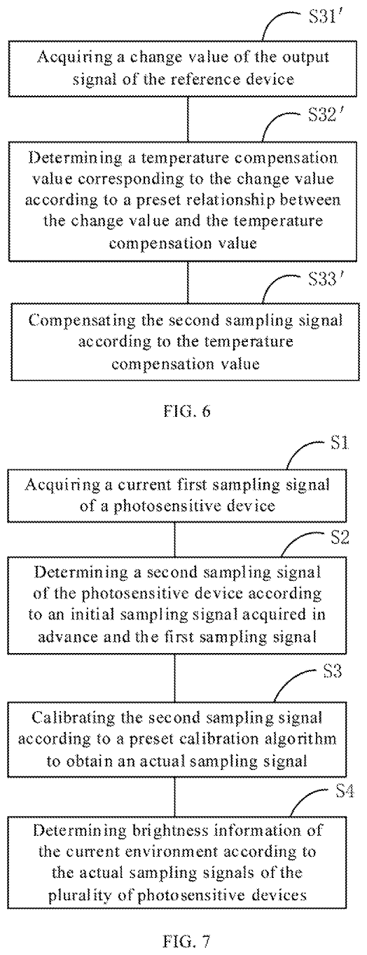

In some examples, referring to FIGS. 6, 14, S3′ may specifically include:

S31′, acquiring a change value of the output signal of the reference device.

Specifically, the change value P4 of the reference device is a difference between the second real-time sampling signal P12 of the reference device obtained under the current ambient illumination and the second dark-state sampling signal P02 of the reference device obtained under the dark state, that is, P4=P12−P03. Because the reference device is not photosensitive, the change value P4 of the reference device may reflect the change in the output signal of the reference device caused by the change in the ambient temperature.

S32′, determining a temperature compensation value corresponding to the change value according to a preset relationship between the change value and the temperature compensation value.

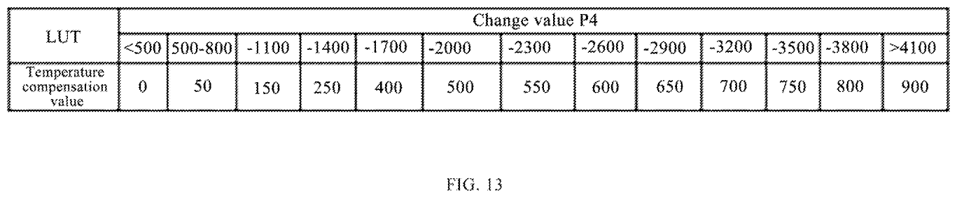

Specifically, the relationship between the change value P4 of the reference device and the temperature compensation value may be obtained by testing in advance. Referring to FIGS. 13 and 14, the second dark-state sampling signal P02 of the reference device is obtained in the normal temperature and the dark state, the output signals of the reference device at different temperatures are tested in advance, a correspondence among the change values P4 of the reference device at different ambient temperatures is determined according to differences between the output signals of the reference device at different ambient temperatures and the second dark-state sampling signal P02, a deviation between the second real-time sampling signal obtained by the reference device at the ambient temperature and the actual brightness is tested, so as to determine the temperature compensation value. The temperature compensation value may eliminate the deviation for the second real-time sampling signal generated by the reference device at the ambient temperature, so as to obtain a correspondence between the change value of one reference device and the temperature compensation value at the ambient temperature corresponding to the change value P4, forming a lookup table LUT including the correspondence between the change values P4 at ambient temperatures and the temperature compensation value, the lookup table LUT may be stored in the ROM 04.

S33′, compensating the second sampling signal P2 according to the temperature compensation value.

In some examples, S33′ specifically includes:

S331′, summing the temperature compensation value and the second sampling signal P2 to compensate the second sampling signal P2.

Specifically, the temperature compensation value and the second sampling signal P2 may be summed to obtain a temperature compensated second sampling signal P2′. For example, when the signal processing circuit 101 acquires the second real-time sampling signal P12 of the reference device, the RAM 03 calls the LUT in the ROM 04, and then inputs the second real-time sampling signal P12 and the LUT into the MCU 06, the MCU 06 determines the change value P4 of the reference device according to the difference between the second dark-state sampling signal P02 and the second real-time sampling signal P12 of the reference device, and then the temperature compensation value corresponding to the change value P4 is looked up in the LUT, sums the temperature compensation value and the second sampling signal P2 to obtain the temperature compensated second sampling signal P2′, so as to eliminate the deviation of the photosensitive device due to the change in the ambient temperature.

In some examples, referring to FIG. 7, a plurality of photosensitive devices are included, and the method may further include:

S4, determining brightness information of the current environment according to the actual sampling signals P3 of the plurality of photosensitive devices.

The photosensitive sampling circuit may include a plurality of photosensitive devices 100, and may also include one photosensitive device 100. If the photosensitive sampling circuit includes a plurality of photosensitive devices 100, the photosensitive sampling circuit receives a sampling signal of each photosensitive device in the plurality of photosensitive devices 100, calibrates each sampling signal to obtain each actual sampling signal, converts the actual sampling signals of the plurality of photosensitive devices 100 into brightness information, and transmits the brightness information to the dimming unit 102; if only one photosensitive device 100 is included, the actual sampling signal obtained from the sampling signal of the photosensitive device 100 is the brightness information, which may be specifically set as needed, and is not limited herein.

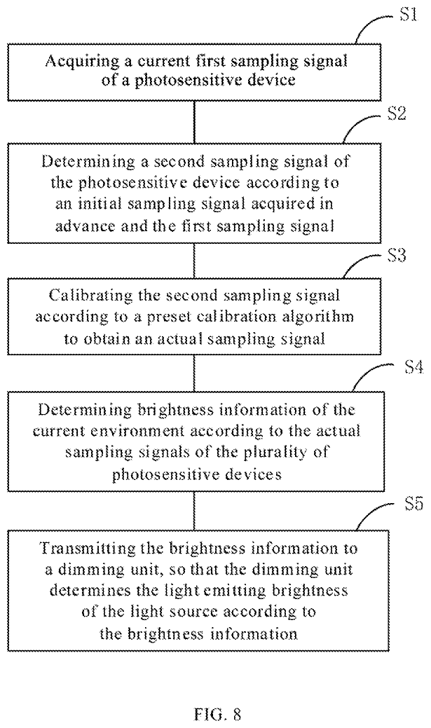

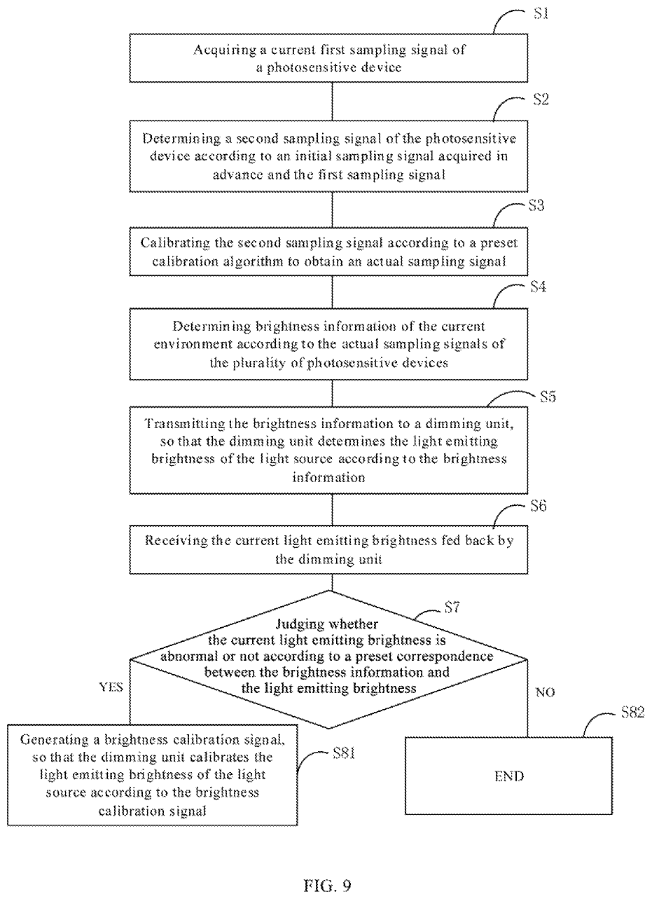

In some examples, referring to FIGS. 8, 14, the method may further include:

S5, transmitting the brightness information to a dimming unit, so that the dimming unit may determine the light emitting brightness of the light source according to the brightness information.

Referring to FIG. 2a, the display panel may further include a dimming unit 102 connected to the signal processing circuit 101, and configured to determine the light emitting brightness of the light source according to the brightness information corresponding to the actual sampling signal P2 of the photosensitive device input by the signal processing circuit 101. In practical applications, for example, in a strong light environment with the direct sunlight, the photosensitive device detects a strong first sampling signal, which is calibrated by the signal processing circuit 101 according to the method, and then an actual sampling signal P3 is obtained. If the plurality of photosensitive devices are included, the brightness information of the current ambient light is obtained according to the actual sampling signals P3 of the plurality of photosensitive devices and is transmitted to the dimming unit 102; and after receiving the brightness information indicating strong light, the dimming unit 102 determines the brightness of white light of a corresponding light source. For example, the light emitting brightness is adjusted to 100%, and then the dimming unit 102 may adjust the light emitting brightness of the display panel to 100%, so that a user may clearly see a display picture of the display panel in the strong light environment.

In some examples, referring to FIGS. 9, 14, the method further includes:

S6, receiving the current light emitting brightness fed back by the dimming unit.

Specifically, after the dimming unit receives the brightness information input by the photosensitive sampling circuit and generates the light emitting brightness of the light source according to the brightness information, the light emitting brightness of the display panel is adjusted according to the light emitting brightness, and the adjusted light emitting brightness LUX′ of the display panel is returned to the photosensitive sampling circuit.

S7, judging whether the current light emitting brightness is abnormal or not according to a preset correspondence between the brightness information and the light emitting brightness.

With reference to FIGS. 9 and 14, the lookup table including the correspondence between the brightness information of the photosensitive sampling circuit and the light emitting brightness may be stored in the ROM 04 of the photosensitive sampling circuit, where the correspondence between the brightness information of the photosensitive sampling circuit and the light emitting brightness in the lookup table may be generated by performing an illumination test on the photosensitive device in advance, or may be generated according to a preset algorithm and based on the correspondence between the light emitting brightness fed back by the dimming unit many times and the brightness information transmitted by the photosensitive sampling circuit. For example, for the same brightness information, the average value of the light emitting brightness fed back by the dimming unit N times and corresponding to the brightness information is used as the light emitting brightness corresponding to the brightness information. N is a positive integer greater than 2.

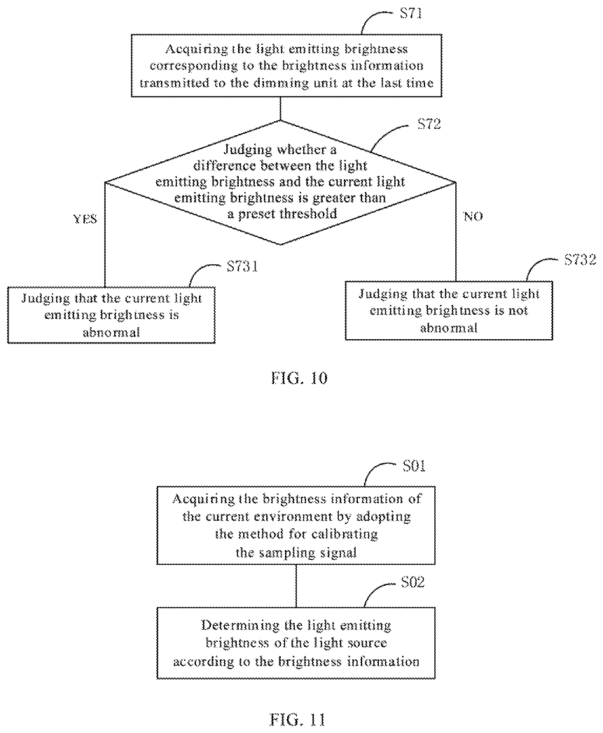

Specifically, referring to FIG. 10, S7 may specifically include:

S71, acquiring the light emitting brightness corresponding to the brightness information transmitted to the dimming unit at the last time.

Specifically, after the photosensitive sampling circuit receives the light emitting brightness fed back by the dimming unit, the MCU 06 may determine the light emitting brightness corresponding to the brightness information transmitted to the dimming unit at the last time according to the lookup table.

S72, judging whether a difference between the light emitting brightness and the current light emitting brightness is greater than a preset threshold.

Specifically, the MCU 06 may compare the difference between the searched light emitting brightness and the current light emitting brightness fed back by the dimming unit with the preset threshold, and determine whether the difference is greater than the preset threshold. The preset threshold may be a preset reference judgment value used as abnormal brightness, and may be any value, which is not limited herein.

S731, if the difference is greater than the preset threshold, judging that the current light emitting brightness is abnormal, and executing S81.

S732, if the difference is less than or equal to the preset threshold, judging that the current light emitting brightness is not abnormal, executing S82 of not operating and ending the judgment.

S81, if the current light emitting brightness is abnormal, the MCU 06 generates a brightness calibration signal, wherein the brightness calibration signal includes the light emitting brightness corresponding to the brightness information transmitted at the last time in the lookup table of the brightness information and the light emitting brightness. Therefore, the dimming unit calibrates the light emitting brightness of the light source according to the light emitting brightness in the brightness calibration signal and adjusts the light emitting brightness to the light emitting brightness in the brightness calibration signal, so that problems such as the accidental signal jump may be prevented, the wrong adjustment for the brightness may be prevented, and the reliability of the brightness adjusting method for the display apparatus in the embodiment of the present disclosure may be further ensured.

Referring to FIG. 11, an embodiment of the present disclosure provides an adjustment method for a display apparatus, which may further include:

S01, acquiring the current brightness information by adopting the brightness adjusting method for the display apparatus.

Specifically, the photosensitive device 100 in the photosensitive sampling circuit transmits the sampling signal to the signal processing circuit 101, the signal processing circuit 101 calibrates the sampling signal to obtain the actual sampling signal P3, and brightness information reflecting the brightness of the current environment is obtained according to the actual sampling signals P3 of one or more photosensitive devices 100 and is transmitted to the dimming unit 102.

S02, determining the light emitting brightness of the light source according to the brightness information.

Specifically, the dimming unit 103 determines backlight information of the light source according to the brightness information transmitted by the photosensitive sampling circuit, and adjusts the light emitting brightness of the display panel according to the backlight information.

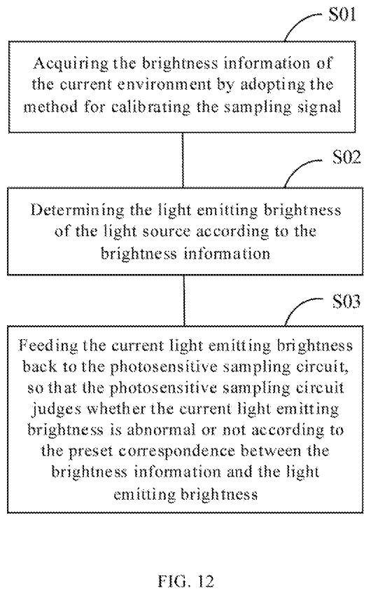

In some examples, referring to FIG. 12, the dimming method in the present embodiment may further include:

S03, feeding the current light emitting brightness back to the photosensitive sampling circuit, so that the photosensitive sampling circuit judges whether the current light emitting brightness is abnormal or not according to the preset correspondence between the brightness information and the light emitting brightness.

Specifically, after the dimming unit 102 receives the brightness information input by the photosensitive sampling circuit and generates the light emitting brightness of the light source according to the brightness information, the dimming unit 102 adjusts the light emitting brightness of the display panel according to the light emitting brightness, and then the adjusted light emitting brightness LUX′ of the display panel is returned to the photosensitive sampling circuit; the photosensitive sampling circuit may check whether the light emitting brightness of the dimming unit 102 is abnormal or not according to the actual light emitting brightness LUX′; if the light emitting brightness of the dimming unit 102 is abnormal, the photosensitive sampling circuit generates a brightness calibration signal and transmits the brightness calibration signal to the dimming unit 102, the dimming unit 102 generates the calibrated light emitting brightness according to the brightness calibration signal and adjusts the light emitting brightness of the light source again; and if the light emitting brightness of the dimming unit 102 is not abnormal, no adjustment is made.

In a second aspect, referring to FIG. 2a, an embodiment of the present disclosure provides a brightness adjusting system for a display apparatus, including a photosensitive sampling circuit, where the photosensitive sampling circuit includes a photosensitive device 100 and a signal processing circuit 101, and is configured to implement steps in the brightness adjusting method for the display apparatus in any one of the above embodiments.

In some examples, with continued reference to FIG. 2a, the brightness adjusting system for the display apparatus in the embodiment of the present disclosure further includes a dimming unit 102 configured to receive the brightness information fed back by the signal processing circuit 101 of the photosensitive sampling circuit, and determine the light emitting brightness of the light source according to the brightness information. The dimming unit 102 is further configured to feed back the current light emitting brightness to the signal processing circuit 101 of the photosensitive sampling circuit, so that the signal processing circuit 101 determines whether the current light emitting brightness is abnormal or not according to a preset correspondence between the brightness information and the light emitting brightness.

Referring to FIG. 2a, the photosensitive sampling circuit of the brightness adjusting system for the display apparatus according to the embodiment of the present disclosure includes a photosensitive device 100 and a signal processing circuit 101, a sampling signal of the photosensitive device 100 is input into the signal processing circuit 101, and the signal processing circuit 101 processes the sampling signal of the photosensitive device 100 to calibrate the sampling signal, so as to ensure the accuracy of the sampling signal.

Referring to FIG. 2a, the signal processing circuit 101 may include at least an analog-to-digital converter (ADC) 02, a microcontroller unit (MCU) 06, and a random access memory (RAM) 03 connected between the ACD 02 and the MCU 06. The ADC 02 is connected to at least one photosensitive device 100, and is configured to convert an output signal (analog voltage) of the at least one photosensitive device 100 into a sampling signal (digital signal); the RAM 03 is configured to temporarily store the received sampling signal therein, call a preset calibration algorithm from an internal or external memory, and transmit the sampling signal and the preset calibration algorithm to the MCU 06; the MCU 06 is configured to calibrate the sampling signal according to the preset calibration algorithm.

In some examples, the signal processing circuit 101 may also include a front end sub-circuit (AFE) 01, a read only memory (ROM) 04, a digital signal processor (DSP) 05, and a serial peripheral interface (SPI) 07. The AFE 01 is electrically connected to the photosensitive device 100, and is configured to convert an output current of the photosensitive device 100 into an output voltage and amplify the output voltage; the ADC 02 is electrically connected to the AFE 01, and is configured to convert an output signal (analog voltage) into a sampling signal (digital signal); the RAM 03 is electrically connected to the ADC 02, and the RAM 03 is configured to read and temporarily store the sampling signal input by the ADC 02 therein and read a required algorithm or data from the ROM 04; the ROM 04 is electrically connected to the RAM 03, and is configured to store data which need to be stored for a long time and are adopted by the signal processing circuit 101, such as algorithms and lookup tables or the like; the DSP 05 receives the sampling signal and the algorithm input by the RAM 03 and may preprocess the sampling signal; the MCU 06 receives the preprocessed sampling signal and the algorithm input by the DSP 05, may process the sampling signal according to a preset algorithm to obtain the calibrated sampling signal, then transmit the calibrated sampling signal to the SPI 07, which, in turn, inputs the calibrated sampling signal to the dimming unit 102 of the display panel, and the dimming unit 102 determines the light emitting brightness of the light source according to the brightness information corresponding to the sampling signal.

It should be noted that in the photosensitive sampling circuit, the output signal of the photosensitive device 100 is input to the signal processing circuit 101 and then converted by the ADC 02 into the digital signal, so that the sampling signals processed in the brightness adjusting method for the display apparatus according to the embodiment of the present disclosure are all digital signals. The sampling signals are, for example, a first sampling signal, an initial sampling signal, a second sampling signal, and the like.

In some examples, the display apparatus includes a display panel and a driving unit connected to the display panel, the driving unit is configured to provide a driving signal to the display panel. The photosensitive sampling circuit in the above system includes at least one photosensitive device and at least one reference device, wherein referring to FIG. 2c, the photosensitive device and the reference device are both phototransistors as an example, and in FIG. 2c, the phototransistors T11, T12 and T13 are photosensitive devices; the phototransistors T21, T22 and T23 are reference devices. The photosensitive devices and the reference devices may be integrated in the display panel, which can save a space and a cost for the display panel comparing with the external photosensitive module. The photosensitive sampling circuit also includes the signal processing circuit 101 connected to the at least one photosensitive device and the at least one reference device, and the signal processing circuit 101 may be integrated in the driving unit, which can save space for the display apparatus.

In some examples, the brightness adjusting system for the display apparatus includes a dimming unit. Referring to FIG. 15, the dimming unit includes an acquisition module 21 and a light source brightness module 22. The acquisition module 21 is configured to acquire brightness information of a current environment by using the above calibration method for the sampling signal. The light source brightness module 22 is connected to the acquisition module 21, and is configured to determine the light emitting brightness of the light source according to the brightness information.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. A brightness adjusting method for a display apparatus comprising a photosensitive sampling circuit, wherein the photosensitive sampling circuit comprises at least one photosensitive device;
wherein the method comprises:
acquiring a current first sampling signal of each of the at least one photosensitive device;
determining a second sampling signal of the photosensitive device according to an initial sampling signal acquired in advance and the first sampling signal; and
calibrating the second sampling signal according to a preset calibration algorithm to obtain an actual sampling signal.

2. The method of claim 1, wherein the photosensitive sampling circuit further comprises a reference device; and
the method further comprises acquiring the initial sampling signal; and
wherein the initial sampling signal is a difference between signals acquired by the photosensitive device and the reference device in a dark state.

3. The method of claim 1, wherein the photosensitive sampling circuit further comprises a reference device; and
the acquiring a current first sampling signal of each of the at least one photosensitive device comprises:
determining a first real-time sampling signal of the photosensitive device and a second real-time sampling signal of the reference device; and
generating the first sampling signal of the photosensitive device according to a difference between the first real-time sampling signal and the second real-time sampling signal.

4. The method of claim 3, wherein the determining a second sampling signal of the photosensitive device according to an initial sampling signal acquired in advance and the first sampling signal comprises:
generating the second sampling signal of the photosensitive device according to a difference between the initial sampling signal and the first sampling signal.

5. The method of claim 3, wherein before the calibrating the second sampling signal according to a preset calibration algorithm to obtain an actual sampling signal, the method further comprises:
compensating the second sampling signal according to an ambient temperature.

6. The method of claim 5, wherein the photosensitive sampling circuit further comprises a reference device; and
the compensating the second sampling signal according to an ambient temperature comprises:
acquiring a change value of an output signal of the reference device;
determining a temperature compensation value corresponding to the change value according to a preset relationship between the change value and the temperature compensation value; and
compensating the second sampling signal according to the temperature compensation value.

7. The method of claim 6, wherein the compensating the second sampling signal according to the temperature compensation value comprises:
summing the temperature compensation value and the second sampling signal to compensate the second sampling signal.

8. The method of claim 1, wherein the preset calibration algorithm comprises a plurality of brightness segments, each of which is provided with a corresponding calibration function.

9. The method of claim 8, wherein an independent variable of the calibration function is the second sampling signal and a dependent variable of the calibration function is the actual sampling signal; and the calibration function for each of the plurality of brightness segments is a linear function.

10. The method of claim 9, wherein the plurality of brightness segments comprise eight brightness segments; and
the calibration functions F(X) for the eight brightness segments are:
F(X)=0.0485·X+0.983, 0≤X<105.532;
F(X)=0.1267·X−7.2696, 105.532≤X<275.7185;
F(X)=0.1878·X−24.116, 275.7185≤X<417.0865;
F(X)=0.2918·X−67.493, 417.0865≤X<576.4973;
F(X)=0.4217·X−142.38, 576.4973≤X<752.4153;
F(X)=0.6018·X−277.89, 752.4153≤X<948.6758;
F(X)=0.9001·X−560.88, 948.6758≤X<1201.839; and
F(X)=1.5091·X−1292.8, 1201.839≤X; and
wherein X is the second sampling signal.

11. The method of claim 1, wherein the at least one photosensitive device comprises a plurality of photosensitive devices, and
the method further comprises determining brightness information of a current environment according to the actual sampling signal of each of the plurality of photosensitive devices.

12. The method of claim 11, wherein the display apparatus further comprises a dimming unit and a light source, and
the method further comprises transmitting the brightness information to the dimming unit, so that the dimming unit determines a light emitting brightness of the light source according to the brightness information.

13. The method of claim 12, wherein the method further comprises:
receiving a current light emitting brightness fed back by the dimming unit;
judging whether the current light emitting brightness is abnormal or not according to a preset correspondence between the brightness information and the light emitting brightness; and
in response to the current light emitting brightness being abnormal, generating a brightness calibration signal, so that the dimming unit calibrates the light emitting brightness of the light source according to the brightness calibration signal.

14. The method of claim 13, wherein the judging whether the current light emitting brightness is abnormal or not according to a preset correspondence between the brightness information and the light emitting brightness comprises:
acquiring the light emitting brightness corresponding to the brightness information last transmitted to the dimming unit;
judging whether a difference between the light emitting brightness and the current light emitting brightness is greater than a preset threshold; and
in response to the difference between the light emitting brightness and the current light emitting brightness being greater than a preset threshold, judging that the current light emitting brightness is abnormal.

15. The method of claim 11, wherein the display apparatus further comprising a light source, and
the method further comprises:
receiving the brightness information fed back by the photosensitive sampling circuit; and
determining a light emitting brightness of the light source according to the brightness information.

16. The method of claim 15, wherein the method further comprises:
feeding the current light emitting brightness back to the photosensitive sampling circuit, so that the photosensitive sampling circuit judges whether the current light emitting brightness is abnormal or not according to a preset correspondence between the brightness information and the light emitting brightness.

17. A brightness adjusting system for a display apparatus, comprising a photosensitive sampling circuit configured to implement the method of claim 11.

18. The brightness adjusting system of claim 17, further comprising a dimming unit configured to receive the brightness information fed back by the photosensitive sampling circuit; and determine a light emitting brightness of a light source according to the brightness information.

19. The brightness adjusting system of claim 17, wherein the photosensitive sampling circuit comprises:
at least one photosensitive device; and
a signal processing circuit connected to the at least one photosensitive device and configured to generate the brightness information according to an output signal of the at least one photosensitive device.

20. The brightness adjusting system of claim 19, wherein the signal processing circuit comprises: an analog-to-digital converter, a microcontroller unit and a random access memory connected between the analog-to-digital converter and the microcontroller unit; wherein,
the analog-to-digital converter is connected to the at least one photosensitive device and is configured to convert an output signal of the at least one photosensitive device into a digital signal; the random access memory is configured to temporarily store the digital signal therein, call the preset calibration algorithm and transmit the digital signal and the preset calibration algorithm to the microcontroller unit; and the microcontroller unit is configured to calibrate the digital signal according to the preset calibration algorithm.

21-22. (canceled)
